(19) United States
(12) Patent Application Publication
(10) Pub. No.: US 2017/0187316 A1
(43) Pub. Date: Jun. 29, 2017

(54) POWER SUPPLY SYSTEM

(71) Applicant: DENSO CORPORATION, Kariya-city (JP)

(72) Inventor: Hisaaki KOBAYASHI, Kariya-city (JP)

(73) Assignee: DENSO CORPORATION, Kariya-city (JP)

(21) Appl. No.: 15/388,342

(22) Filed: Dec. 22, 2016

(30) Foreign Application Priority Data
Dec. 25, 2015 (JP) 2015-254444

(51) Int. Cl. H02P 27/06; H02J 7/00; B60L 11/18; H02P 6/14; H02K 7/00

(52) U.S. Cl. CPC H02P 27/06; H02P 6/14; H02K 7/006; B60L 11/18; H02J 7/007

(57) ABSTRACT

A power supply system includes DC-power supplies, an AC rotating electrical machine, an inverter connected between a first power supply and the electrical machine, and a controller controlling switching of switching elements of the inverter. A first end of a second power supply is connected to a terminal of the same polarity side of the first power supply, and a second end of the second power supply is connected to a neutral point of windings of the electrical machine. The electrical machine and a drive shaft are connected or disconnected. When they are disconnected, the controller controls the switching to perform step-down or step-up of the first or second power supply by using the windings. When they are connected, the controller suppresses a current flowing to the windings compared with when they are disconnected to perform step-down or step-up. Electric power is transferred between the first and second power supplies.

### CROSS-REFERENCE TO RELATED APPLICATION

This application is based on and claims the benefit of priority from earlier Japanese Patent Application No. 2015-254444 filed Dec. 25, 2015, the description of which is incorporated herein by reference.

### BACKGROUND

(Technical Field)

The present invention relates to a power supply system including a plurality of different electric power supplies.

(Related Art)

Recently, various power supply systems are proposed which include a plurality of different electric power supplies. In such power supply systems, when electric power is transferred between the different power supplies, the voltage of one of the power supplies is required to be increased (step-up) or decreased (step-down), and another of the power supplies is required to be adjusted. However, if a dedicated circuit is provided for increasing and decreasing the voltage, the power system becomes complicated, and the manufacturing cost becomes high. To solve the problems, according the wide power supply disclosed in JP-A-2000-324857, a step-up and step-down circuit is easily configured without using a dedicated circuit.

The wide power supply disclosed in JP-A-2000-324857 includes a high-voltage battery, a three-phase motor having Y-connected field windings, an inverter interposed between the high-voltage battery and the three-phase motor, and a low-voltage battery. In the apparatus, one terminal of the low-voltage battery and the same polarity side of the high-voltage battery are connected, and the other terminal of the low-voltage battery and the neutral point of the windings are connected, to increase the voltage of the low-voltage battery and decrease the voltage of the high-voltage battery. That is, in the apparatus, the step-up and step-down circuit is configured by the windings of the three-phase motor and switching elements of the inverter to perform neutral point step-up and step-down using the neutral point of the windings.

In the above wide power supply, when the neutral point step-up and step-down is performed, a current flows to the stator side of the motor. Hence, it is difficult to suppress the output of motor torque. If the motor torque is output according to the neutral point step-up and step-down, unintended torque pulsation may be transmitted to a connecting object of the motor, which may affect the condition of the vehicle. For example, when the motor is connected to a drive shaft of the vehicle, if the neutral point step-up and step-down is performed, unintended torque pulsation is transmitted to the drive shaft, which may affect the state of the vehicle.

### SUMMARY

An embodiment provides a power supply system that can suppress the application of unintended torque pulsation to a connecting object of an AC rotating electrical machine to perform step-up and step-down of a power supply.

As an aspect of the embodiment, a power supply system is applied to a vehicle. The system includes: a plurality of different DC power supplies; an AC rotating electrical machine; an inverter that is connected between a first power supply included in the DC power supplies and the AC rotating electrical machine to drive the AC rotating electrical machine, and a controller that controls switching of switching elements of the inverter. A first end of one of at least one second power supply included in the DC power is connected to a terminal of a same polarity side of the first power supply, and a second end of the second power supply is connected to a neutral point of windings of the AC rotating electrical machine. The AC rotating electrical machine and a drive shaft of the vehicle are connected to each other or disconnected from each other. When the AC rotating electrical machine and the drive shaft are disconnected from each other, the controller controls the switching to perform step-down or step-up of the first power supply or the second power supply by using the windings, or when the AC rotating electrical machine and the drive shaft are connected to each other, the controller suppresses a current flowing to the windings compared with when the AC rotating electrical machine and the drive shaft are disconnected from each other to perform the step-down or the step-up, so that electric power is transferred between the first power supply and the second power supply.

### BRIEF DESCRIPTION OF THE DRAWINGS

In the accompanying drawings:

FIG. 1 is a diagram showing a configuration of a vehicle including a power supply system according to a first embodiment;

FIG. 2 is a diagram showing an example of a neutral point step-up and step-down circuit;

FIG. 3 is a diagram showing an example of the neutral point step-up and step-down circuit;

FIG. 4 is a flowchart of a procedure for performing neutral point step-down according to the first embodiment and a second embodiment;

FIG. 5 is a flowchart of a procedure for performing neutral point step-up according to the first and second embodiments;

FIG. 6 is a diagram showing a configuration of a vehicle including a power supply system according to the second embodiment;

FIG. 7 is a diagram showing a configuration of a vehicle including a power supply system according to a third embodiment;

FIG. 8 is a diagram showing an example of the neutral point step-up and step-down circuit;

FIG. 9 is a flowchart of a procedure for performing neutral point step-down according to the third embodiment;

FIG. 10 is a flowchart of a procedure for performing neutral point step-up according to the third embodiment;

FIG. 11 is a diagram showing a configuration of a vehicle including a power supply system according to a fourth embodiment;

FIG. 12 is a diagram showing a configuration of a vehicle including a power supply system according to a modification of the fourth embodiment;

FIG. 13 is a flowchart of a procedure for performing neutral point step-down according to the fourth embodiment and a fifth embodiment;

FIG. 14 is a flowchart of a procedure for performing neutral point step-up according to the fourth embodiment; and

FIG. 15 is a diagram showing a configuration of a vehicle including a power supply system according to the fifth embodiment.

### DETAILED DESCRIPTION OF THE PREFERRED EMBODIMENTS

Hereinafter, embodiments of a power supply system will be described with reference to the drawings. In the embodiments, the power supply system is applied to a vehicle. Note that, in the following embodiments, the same or similar portions are denoted by the same reference numerals in the figures to omit redundant description.

### First Embodiment

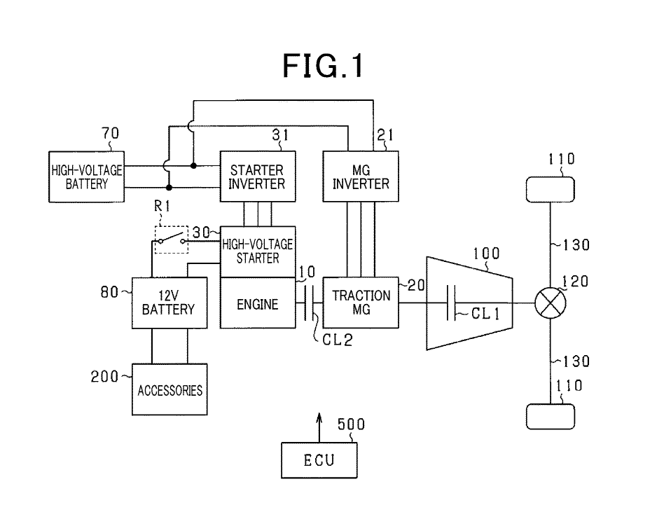

FIG. 1 shows a configuration of a vehicle including a power supply system according to the first embodiment. The vehicle includes an engine 10, a traction MG 20, a high-voltage starter 30, a starter inverter 31, an MG inverter 21, a high-voltage battery 70, a 12V battery 80, accessories 200, a transmission 100, and an ECU 500.

The traction MG 20 is a three-phase motor generator and includes a rotor and a stator around which three-phase coils are wound. Output torque of the traction MG 20 is a traveling drive source of the vehicle. That is, the vehicle is a hybrid vehicle using the output torque of the engine 10 and the traction MG 20 as the traveling drive source. A crankshaft of the engine 10 is connected to a rotary shaft of the traction MG 20 via a clutch CL2. The rotary shaft of the traction MG 20 is connected to an input shaft of the transmission 100. The input shaft of the transmission 100 is connected to an output shaft of the transmission 100 via a clutch CL1. The output shaft of the transmission 100 is connected to a drive shaft 130 via a differential gear 120. Both ends of the drive shaft 130 are connected to wheels 110.

The high-voltage starter 30 is a three-phase AC motor, and includes a rotor and a stator around which three-phase coils are wound. The high-voltage starter 30 applies initial rotation to the crankshaft of the engine 10 when the engine 10 starts. Specifically, when the engine 10 starts, in a state where a gear of the high-voltage starter 30 and a gear of the engine 10 are engaged with and connected to each other, the high-voltage starter 30 is driven to transmit torque of the high-voltage starter 30 to the crankshaft of the engine 10. Except when the engine 10 starts, the high-voltage starter 30 and the engine 10 are separated from each other. When the high-voltage starter 30 is connected to the engine 10, and the clutches CL1 and CL2 are engaged, the high-voltage starter 30 is connected to the drive shaft 130. In addition, when the high-voltage starter 30 is separated from the engine 10, or the clutch CL1 or the clutch CL2 is disengaged, the high-voltage starter 30 is disconnected from the drive shaft 130.

The high-voltage starter 30 is connected with the three-phase starter inverter 31 that drives the high-voltage starter 30. The starter inverter 31 is connected with the high-voltage battery 70 that supplies electric power to the high-voltage starter 30. In addition, the traction MG 20 is connected with the three-phase MG inverter 21 that drives the traction MG 20. The MG inverter 21 is connected with the high-voltage battery 70 that supplies electric power to the traction MG 20. That is, the high-voltage battery 70 is a DC power supply supplying electric power to the high-voltage starter 30 and the traction MG 20. As the high-voltage battery 70, for example, a lithium-ion storage battery or nickel-hydrogen storage battery of several hundred volts can be used.

In addition, a neutral point P of the three-phase coils of the high-voltage starter 30 is connected with the 12V battery 80 via a relay R1. The 12V battery 80 is a DC power supply supplying electric power to the accessories 200 and is connected with the accessories 200. The 12V battery 80 may be, for example, a lead storage battery. The present power supply system includes two DC power supplies, the high-voltage battery 70 and the 12V battery 80.

The ECU 500 (control section) is a microcomputer including a CPU, a ROM, a RAM, and an I/O. In the ECU 500, the CPU executes a program stored in the ROM to perform various controls of the vehicle such as controls of the engine 10, the traction MG 20, the high-voltage battery 70, the 12V battery 80, the relay R1, the clutches CL1 and CL2, and an air conditioner. In practice, the ECU 500 includes a plurality of ECUs such as an engine ECU controlling the engine 10, a motor ECU controlling the MG inverter 21, a battery ECU monitoring SOCs (State of charge: charging rate) of the high-voltage battery 70 and the 12V battery 80, an air conditioner ECU controlling the air conditioner, and a hybrid ECU managing a hybrid system.

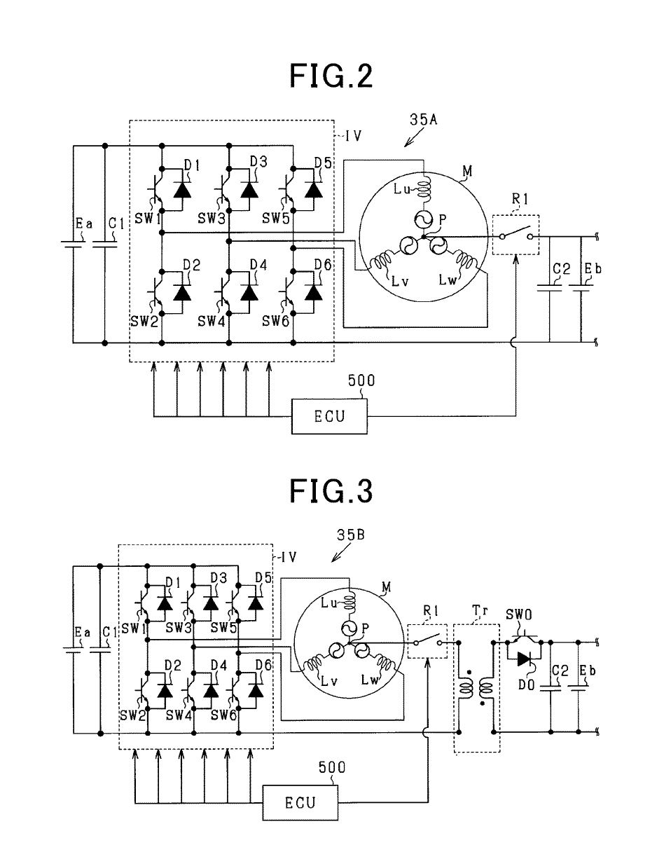

Next, a neutral point step-up and step-down circuit using the motors and the circuits of the present power supply system will be described. FIG. 2 shows a neutral point step-up and step-down circuit 35A, which is the first example of the neutral point step-up and step-down circuit according to the present embodiment. The neutral point step-up and step-down circuit 35A includes a motor M (AC rotating electrical machine) and an inverter IV driving the motor M. In the present embodiment, the high-voltage starter 30 serves as the motor M, and the starter inverter 31 serves as the inverter IV. Electric power is transferred between the high-voltage battery 70 and the 12V battery 80 by using the neutral point step-up and step-down circuit 35A. At this time, the high-voltage starter 30 and the drive shaft 130 are disconnected from each other. That is, the high-voltage starter 30 and the engine 10 are disconnected from each other. Alternatively, the clutch CL2 is disengaged. When the vehicle is stopped, the clutch CL1 may be disengaged.

The motor M is an AC motor in which three-phase coils Lu, Lv, and LW (field windings) are Y-connected. The inverter IV is a three-phase inverter in which each phase is configured by a series connection of two switching elements. Diodes are respectively connected to the switching elements in antiparallel. Connecting points of the switching elements of the phases are connected to the respective coils of the phases. The switching elements may be IGBTs or MOS transistors.

The neutral point P of the three-phase coils Lu, Lv, and Lw is connected with a first end of the relay R1. A second end of the relay R1 is connected with a positive electrode terminal of a power supply Eb (second power supply). In addition, high-potential side terminals of the phases of the inverter IV are connected with a positive electrode terminal of the power supply Ea (first power supply). Low-potential side terminals of the phases are connected with a negative electrode terminal of the power supply Ea. The negative electrode terminal of the power supply Ea, low-potential side terminals of the inverter IV, and a negative electrode terminal of the power supply Eb are connected to each other. The power supply Ea and the power supply Eb are respectively connected with a smoothing capacitor C1 and a smoothing capacitor C2 in parallel. In the present embodiment, the high-voltage battery 70 serves as the power supply Ea, and the 12V battery 80 serves as the power supply Eb. If the relay R1 is closed, the positive terminal of the power supply Eb is connected to the neutral point P. Thereby, the switching elements and the diodes of each of the phases, the coil of each of the phases, and the smoothing capacitors C1 and C2 form a chopper circuit. For example, in the case of the U phase, the switching elements SW1 and SW2, the diodes D1 and D2, and the coil Lu of the U phase and the smoothing capacitors C1 and C2 form a chopper circuit. When neutral point step-down (decreasing voltage) is performed by using the coil Lu of the U phase, the duty ratio of on and off of the switching element SW1 is controlled to decrease the voltage of the power supply Ea to supply electric power of the power supply Ea to the power supply Eb. Thereby, the 12V battery 80 is charged with the electric power of the high-voltage battery 70. In this case, the switching element SW2 may be turned on and off in a complementary manner with the switching element SW1 to perform synchronous rectification. Alternatively, the switching element SW2 may be kept in an off state to perform rectification by the diode D2.

In addition, when neutral point step-up (increasing voltage) is performed by using the coil Lu of the U phase, the duty ratio of on and off of the switching element SW2 is controlled to increase the voltage of the power supply Eb to supply electric power of the power supply Eb to the power supply Ea. Thereby, the high-voltage battery 70 is charged with the electric power of the 12V battery 80. In this case, the switching element SW1 may be turned on and off in a complementary manner with the switching element SW2 to perform synchronous rectification. Alternatively, the switching element SW1 may be kept in an off state to perform rectification by the diode Dl. The neutral point step-up and step-down may be performed by using the coils of two phases or the coils of three phases. Note that the switching elements of the relay R1 and the inverter IV are opened and closed and turned on and off based on control commands transmitted from the ECU 500.

When performing the neutral point step-up and step-down (increasing voltage and decreasing voltage), the ECU 500 performs the control so that the current flowing to the inverter IV does not become excessive. Specifically, the ECU 500 makes the sum of a torque output current corresponding to the output torque of the motor M and input and output currents input to and output from the neutral point P according to the neutral point step-up and step-down smaller than an upper limit threshold value Ith, which is the maximum current allowed to flow to the inverter IV. If the neutral point step-up and step-down is performed when the engine 10 starts, the sum of a torque output current generating torque applied from the motor M to the engine 10 and input and output currents according to the neutral point step-up and step-down flows to the inverter IV. The ECU 500 controls switching of the switching elements so that the sum of the currents becomes less than the upper limit threshold value Ith of the output current of the inverter IV, to perform the neutral point step-up and step-down.

Note that except when the engine 10 starts, a torque output current corresponding to the output torque of the motor M does not flow to the inverter IV. Hence, except when the engine 10 starts, switching of the inverter IV may be controlled so that input and output currents according to the neutral point step-up and step-down become less than the upper limit threshold value Ith.

In addition, the threshold value of the SOC for determining whether or not charging is performed is defined as a first threshold value Sth1, and a value lower than the first threshold value Sth1 is defined as a second threshold value Sth2. The second threshold value Sth2 is a threshold value for determining whether or not quick charging is required. If at least one of the temperatures of the motor M and the inverter IV is higher than a temperature threshold value Tth, and the SOC of the power supply Ea or the power supply Eb, which is a target to be charged, is higher than the second threshold value Sth2 (charging threshold value), the ECU 500 lowers the upper limit threshold value Ith of the output current of the inverter IV. That is, when at least one of the temperatures of the motor M and the inverter IV is relatively high, and the SOC of the target to be charged is not required to be increased quickly, step-up electric energy or step-down electric energy is decreased to lower the temperatures of the motor M and the inverter IV. Note that the first threshold value Sth1 and the second threshold value Sth2 are set depending on the type of the power supply Ea and the power supply Eb, respectively. For example, the first threshold value Sth1 and the second threshold value Sth2, which differ from each other, are set for the high-voltage battery 70 and the 12V battery 80, respectively.

Next, FIG. 3 shows a neutral point step-up and step-down circuit 35B, which is the second example of the neutral point step-up and step-down circuit according to the present embodiment. The neutral point step-up and step-down circuit 35B differs from the neutral point step-up and step-down circuit 35A in that the power supply Eb is connected to the neutral point P via an isolation transformer Tr. Specifically, a high-potential side terminal of the smoothing capacitor C2 is connected with a first end of a switching element SW0 and a cathode terminal of a diode D0. The isolation transformer Tr is connected between both a second end of the switching element SW0 and an anode terminal of the diode and a low-potential side terminal of the smoothing capacitor C2, and between the second end of the relay R1 and the low-potential side terminal of the inverter IV. Thereby, the high voltage sides of the inverter IV and the power supply Ea and the low voltage side of the power supply Eb are insulated from each other.

In the neutral point step-up and step-down circuit 35A, since the Low-potential side terminal of the inverter IV and the negative electrode terminal of the power supply Eb are always connected, switching noise at the high voltage side may be introduced to the low voltage side. In addition, when leakage is caused at the high voltage side, high voltage may be introduced to the low voltage side. In contrast, in the neutral point step-up and step-down circuit 35B, since the high voltage side and the low voltage side are insulated from each other, switching noise at the high voltage side is not introduced to the low voltage side. In addition, even when leakage is caused at the high voltage side, high voltage is not introduced to the low voltage side. Hence, the neutral point step-up and step-down circuit 35B has safety greater than that of the neutral point step-up and step-down circuit 35A.

In addition, by appropriately setting a turn ratio of the isolation transformer Tr, the power supply Eb can be a higher-voltage power supply compared with the power supply Ea. That is, the power supply Ea may be the 12V battery 80, and the power supply Eb may be the high-voltage battery 70.

Furthermore, the step-up and step-down circuit including the isolation transformer Tr may be configured not only as a flyback circuit using the coils of the motor M, but also by connecting the isolation transformer Tr to a half-bridge or full-bridge DCDC converter existing in vehicles. Using at least one of the switching elements of the inverter IV also as a switching element configuring the existing DCDC converter can lower the manufacturing cost.

According to the present embodiment, when the neutral point step-up and step-down is performed, a current flows to a coil of the high-voltage starter 30. Hence, it is difficult to completely suppress the output of motor torque of the high-voltage starter 30. If unintended torque pulsation due to the neutral point step-up and step-down is transmitted to the drive shaft 130, the torque pulsation may affect the condition of the vehicle. When the vehicle is running, if the unintended torque pulsation is transmitted to the drive shaft 130, the torque pulsation may affect the running condition of the vehicle. Even when the vehicle is stopped, if the unintended torque pulsation is transmitted to the drive shaft 130, the torque pulsation may give the vehicle a shock. In this regard, since the neutral point step-up and step-down is performed in a state where the high-voltage starter 30 and the drive shaft 130 are disconnected from each other, torque pulsation due to the neutral point step-up and step-down is not transmitted to the drive shaft 130. That is, the neutral point step-up and step-down does not affect the condition of the vehicle.

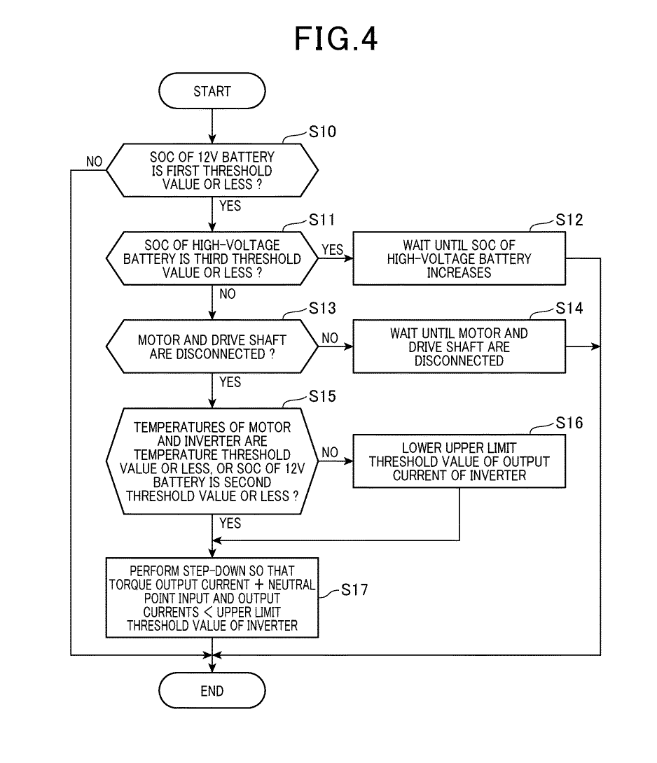

Next, a procedure for performing the neutral point step-down will be described with reference to the flowchart shown in FIG. 4. The present procedure is repeatedly performed by the ECU 500 at predetermined intervals.

First, in step S10, the ECU 500 determines whether or not the SOC of the 12V battery 80 is the first threshold value Sth1 or less. That is, the ECU 500 determines whether or not the 12V battery 80 is required to be charged. If the SOC of the 12V battery 80 is more than the first threshold value Sth1 (S10: NO), charging is not required. Hence, the present process is ended.

If the SOC of the 12V battery 80 is the first threshold value Sth1 or less (S10: YES), in step S11, the ECU 500 determines whether or not the SOC of the high-voltage battery 70 is a third threshold value Sth3 or less. The third threshold value Sth3 is a threshold value for determining whether or not the SOC is sufficient to perform discharging. The third threshold value Sth3 is set depending on the type of the battery. If the SOC of the high-voltage battery 70 is the third threshold value Sth3 or less (S11: YES), in step S12, the ECU 500 waits until the SOC of the high-voltage battery 70 exceeds the third threshold value Sth3. Then, the present process is ended.

In contrast, if the SOC of the high-voltage battery 70 is more than the third threshold value Sth3 (S11: NO), next in step S13, the ECU 500 determines whether or not the high-voltage starter 30 and the drive shaft 130 are disconnected from each other. That is, the ECU 500 determines whether or not the high-voltage starter 30 and the engine 10 are disconnected from each other, or the clutch CL1 or the clutch CL2 is disengaged. If the high-voltage starter 30 and the drive shaft 130 are not disconnected from each other (S13: NO), in step S14, the ECU 500 waits until the high-voltage starter 30 and the drive shaft 130 are disconnected from each other. Then, the present process is ended.

In contrast, if the high-voltage starter 30 and the drive shaft 130 are disconnected from each other (S13: YES), next in step S15, the ECU 500 determines whether or not the temperatures of the high-voltage starter 30 and the starter inverter 31 are the temperature threshold value Tth or less, or whether or not the SOC of the 12V battery 80 is the second threshold value Sth2 or less. If the temperature of the high-voltage starter 30 or the starter inverter 31 is more than the temperature threshold value Tth, and the SOC of the 12V battery 80 is more than the second threshold value Sth2 (S15: NO), in step S16, the ECU 500 lowers the upper limit threshold value Ith of the output current of the starter inverter 31. That is, when the temperature of the high-voltage starter 30 or the starter inverter 31 is higher, and the SOC of the 12V battery 80 is not required to be increased quickly, the ECU 500 lowers the upper limit threshold value Ith. Then, the present process proceeds to step S17.

In contrast, if the temperatures of the high-voltage starter 30 and the starter inverter 31 are the temperature threshold value Tth or less, or the SOC of the 12V battery 80 is the second threshold value Sth2 or less (S15: YES), the present process proceeds to step S17 without change. That is, when the temperature of the high-voltage starter 30 or the starter inverter 31 is lower, or the SOC of the 12V battery 80 is required to be increased quickly, the ECU 500 does not lower the upper limit threshold value Ith, and the present process proceeds to step S17. In step S17, the ECU 500 closes the relay R1, and connects the 12V battery 80 to the neutral point P. Then, the ECU 500 performs the step-down of the voltage of the high-voltage battery 70 (decreases the voltage of the high-voltage battery 70) so that the sum of the torque output current and the neutral point input and output currents according to the step-down becomes less than the upper limit threshold value Ith. Then, the 12V battery 80 is charged with the electric power of the high-voltage battery 70. Then, the present process is ended.

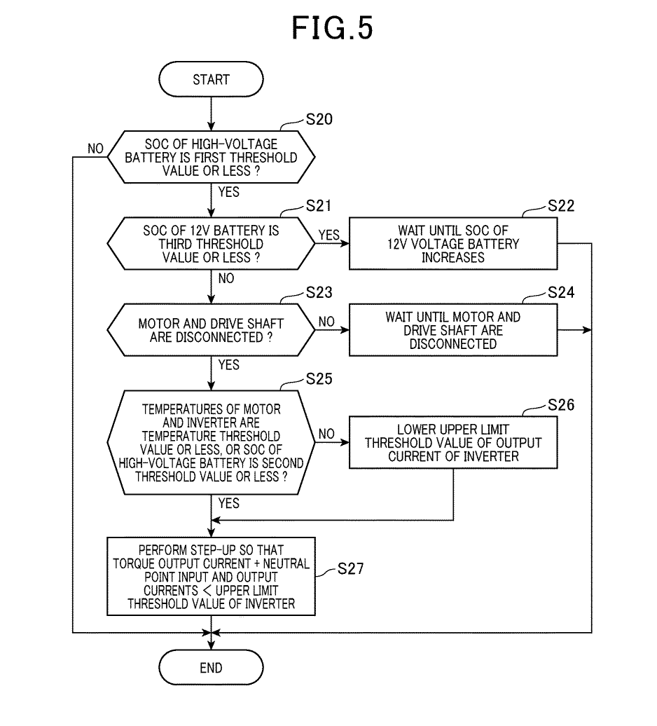

Next, a procedure for performing the neutral point step-up will be described with reference to the flowchart shown in FIG. 5. The present procedure is repeatedly performed by the ECU 500 at predetermined intervals. While the ECU 500 performs the procedure shown in FIG. 4 at predetermined intervals, the ECU 500 performs the procedure shown in FIG. 5 at predetermined intervals.

First, in step S20, the ECU 500 determines whether or not the SOC of the high-voltage battery 70 is the first threshold value Sth1 or less. That is, the ECU 500 determines whether or not the high-voltage battery 70 is required to be charged. If the SOC of the high-voltage battery 70 is more than the first threshold value Sth1 (S20: NO), the charge is not required. Hence, the present process is ended.

If the SOC of the high-voltage battery 70 is the first threshold value Sth1 or less (S20: YES), in step S21, the ECU 500 determines whether or not the SOC of the 12V battery 80 is the third threshold value Sth3 or less. If the SOC of the 12V battery 80 is the third threshold value Sth3 or less (S21: YES), in step S22, the ECU 500 waits until the SOC of the 12V battery 80 exceeds the third threshold value Sth3. Then, the present process is ended.

In contrast, if the SOC of the 12V battery 80 is more than the third threshold value Sth3 (521: NO), next in step S23, the ECU 500 determines whether or not the high-voltage starter 30 and the drive shaft 130 are disconnected from each other. If the high-voltage starter 30 and the drive shaft 130 are not disconnected from each other (S23: NO), in step S24, the ECU 500 waits until the high-voltage starter 30 and the drive shaft 130 are disconnected from each other. Then, the present process is ended.

In contrast, if the high-voltage starter 30 and the drive shaft 130 are separated from each other (S23: YES), next in step S25, the ECU 500 determines whether or not the temperatures of the high-voltage starter 30 and the starter inverter 31 are the temperature threshold value Tth or less, or whether or not the SOC of the high-voltage battery 70 is the second threshold value Sth2 or less.

If the temperature of the high-voltage starter 30 or the starter inverter 31 is more than the temperature threshold value Tth, and the SOC of the high-voltage battery 70 is more than the second threshold value Sth2 (S25: NO), in step S16, the ECU 500 lowers the upper limit threshold value Ith of the output current of the starter inverter 31. Then, the process proceeds to step S27.

In contrast, if the temperatures of the high-voltage starter 30 and the starter inverter 31 are the temperature threshold value Tth or less, or the SOC of the high-voltage battery 70 is the second threshold value Sth2 or less (S25: YES), the present process proceeds to step S27 without change. In step S27, the ECU 500 closes the relay R1, and connects the 12V battery 80 to the neutral point P. Then, the ECU 500 performs the step-up of the voltage of the 12V battery 80 (increases the voltage of the 12V battery 80) so that the sum of the torque output current and the neutral point input and output currents according to the step-up becomes less than the upper limit threshold value Ith. Then, the high-voltage battery 70 is charged with the electric power of the 12V battery 80. Then, the present process is ended.

According to the first embodiment described above, the following advantageous effects are provided.

(1) Only when the motor M of the neutral point step-up and step-down circuits 35A and 35B and the drive shaft 130 are disconnected, the neutral point step-up and step-down is performed. Hence, the neutral point step-up and step-down can be performed without applying unintended torque pulsation to the drive shaft 130. Furthermore, the neutral point step-up and step-down can be performed without affecting the condition of the vehicle.

(2) Controlling the electric energy for the neutral point step-up and step-down depending on the output torque of the motor M can make the current flowing to the inverter IV equal to or less than the upper limit threshold value Ith of the inverter IV. Hence, the neutral point step-up and step-down can be performed without using the inverter IV having a large current capacity. Furthermore, the manufacturing cost can be reduced.

(3) If at least one of the temperatures of the motor M and the inverter IV is the temperature threshold value Tth or more, and the SOC of the battery, which is a target to be charged, is the second threshold value Sth2 or more, the upper limit threshold value Ith is lowered. Thereby, since the electric power supplied to the motor M and the inverter IV decreases, the temperatures of the motor M and the inverter IV can be lowered.

(4) Only when the motor M and the engine 10 are disconnected from each other, or the clutch CL1 or the clutch CL2 is disengaged, the neutral point step-up and step-down is performed. Hence, the neutral point step-up and step-down can be performed without affecting the condition of the vehicle.

(5) When the power supply Eb is connected to the neutral point P via the isolation transformer Tr, the high voltage side and the low voltage side are insulated from each other. Hence, switching noise having high voltage is not introduced to the low voltage side. In addition, even when leakage is caused at the high voltage side, high voltage is not introduced to the low voltage side. Hence, safety of the power supply system can be improved. Furthermore, even when the high voltage side breaks down, the vehicle can run to evacuate by using the power supply Eb at the low voltage side.

### Second Embodiment

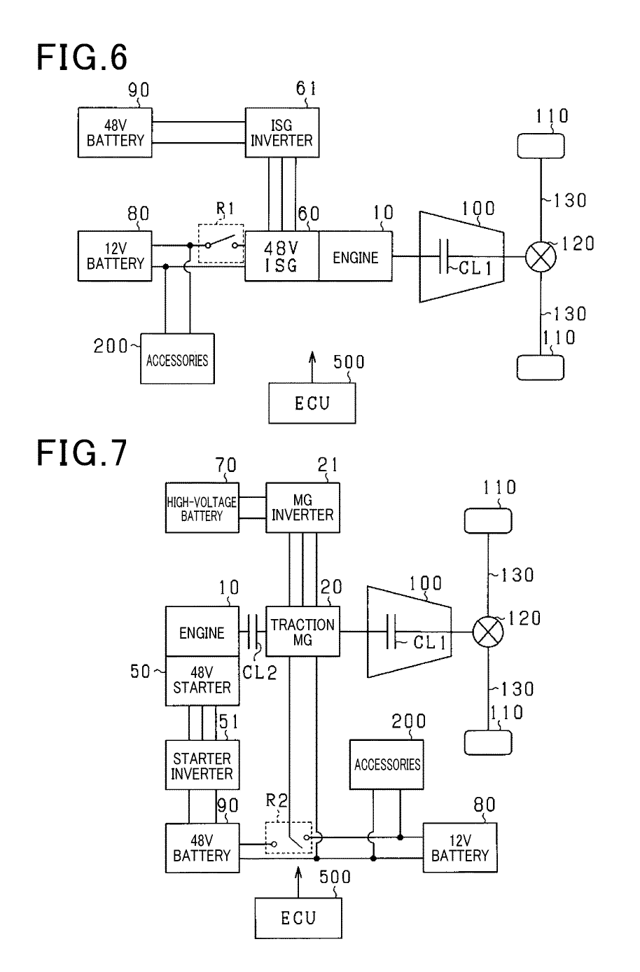

Next, differences of a power supply system according to the second embodiment from the power supply system according to the first embodiment will be described. FIG. 6 shows a configuration of a vehicle including the power supply system according to the second embodiment. The vehicle includes the engine 10, an ISG (Integrated Starter Generator) 60, an ISG inverter 61, a 48V battery 90, the 12V battery 80, the accessories 200, the transmission 100, and the ECU 500.

The ISG 60 is a three-phase AC generator including a motor function activated with 48 V, and includes a rotor and a stator around which three-phase coils are wound. The ISG 60 operates as a starter applying initial rotation to the engine 10 when the engine 10 starts, and operates as a generator when the vehicle deaccelerates to perform regenerative power generation. AC power generated by the ISG 60 is converted to DC power by the ISG inverter 61. The DC power is supplied to the 48V battery 90. Furthermore, the ISG 60 may operate as a motor to assist the engine 10 when the vehicle accelerates.

A rotary shaft of the ISG 60 is connected to a crank pulley of the engine 10 with an ISG belt. Hence, the ISG 60 is connected to the engine 10 all the time. The crankshaft of the engine 10 is connected to the input shaft of the transmission 100. The input shaft of the transmission 100 is connected to an output shaft of the transmission 100 via the clutch CL1. The output shaft of the transmission 100 is connected to the drive shaft 130 via the differential gear 120. Both ends of the drive shaft 130 are connected to the wheels 110. When the clutch CL1 is engaged, the ISG 60 is connected to the drive shaft 130. When the clutch CL1 is disengaged, the ISG 60 is disconnected from the drive shaft 130.

The ISG 60 is connected with the three-phase ISG inverter 61 driving the ISG 60. The ISG inverter 61 is connected with the 48V battery 90, which is a DC power supply supplying electric power to the ISG 60. The 48V battery 90 may be, for example, a lithium-ion storage battery or a nickel-hydrogen storage battery.

In addition, the neutral point P of the three-phase coils of the ISG 60 is connected with the 12V battery 80 via the relay R1. The 12V battery 80 is connected with the accessories 200 and supplies electric power to the accessories 200. The present power supply system includes two DC power supplies, the 12V battery 80 and the 48V battery 90.

In the present embodiment, the ISG 60 and the ISG inverter 61 form the neutral point step-up and step-down circuits 35A and 35 B. That is, in the present embodiment, the ISG 60 servers as the motor M, and the ISG inverter 61 serves as the inverter IV. In addition, the 48V battery 90 serves as the power supply Ea, and the 12V battery 80 serves as the power supply Eb. Electric power is transferred between the 48V battery 90 and the 12V battery 80. At this time, the clutch CL1 is disengaged.

In the present embodiment, in the state where the ISG 60 generates electric power to charge the 48V battery 90, the voltage of the 48V battery 90 may be decreased to charge the 12V battery 80. When performing the neutral point step-up and step-down, the ECU 500 controls switching of the inverter IV so that the sum of a torque output current corresponding to the input torque of the motor M and input and output currents of the neutral point P according to the neutral point step-up and step-down becomes less than the upper limit threshold value Ith of the output current of the inverter IV.

The step-down control of the voltage of the 48V battery 90 is performed according to a procedure similar to that of the flowchart shown in FIG. 4. The step-up control of the voltage of the 12V battery 80 is performed according to a procedure similar to that of the flowchart shown in FIG. 5. In the present embodiment, the 48V battery 90 serves as a high-voltage battery.

According to second embodiment described above, the advantageous effects similar to those of the first embodiment are provided.

### Third Embodiment

Next, differences of a power supply system according to the third embodiment from the power supply system according to the first embodiment will be described. FIG. 7 shows a configuration of a vehicle including the power supply system according to the third embodiment. The vehicle includes the engine 10, the traction MG 20, the MG inverter 21, a 48V starter 50, a starter inverter 51, the high-voltage battery 70, the 12V battery 80, the 48V battery 90, the accessories 200, the transmission 100, and the ECU 500.

The 48V starter 50 is a three-phase AC motor, and includes a rotor and a stator around which three-phase coils are wound. The 48V starter 50 is activated with 48 V. When the engine 10 starts, the 48V starter 50 applies initial rotation to the crankshaft of the engine 10. The 48V starter 50 is connected to the three-phase starter inverter 51 driving the 48V starter 50. The starter inverter 51 is connected with the 48V battery 90 supplying electric power to the 48V starter 50.

The connection between the engine 10, traction MG 20, the MG inverter 21, the high-voltage battery 70, and the transmission 100 is similar to that of the first embodiment. The traction MG 20 is connected to the drive shaft 130 when the clutch CL1 is engaged. The traction MG 20 is disconnected from the drive shaft 130 when the clutch CL1 is disengaged.

The neutral point P of the three-phase coils of traction MG 20 is connected with the 12V battery 80 or the 48V battery 90 via a relay R2. The relay R2 has two contacts. When the first contact of the relay R2 becomes a closed state, the 12V battery 80 is connected to the neutral point P. When the second contact of the relay R2 becomes a closed state, the 48V battery 90 is connected to the neutral point P. The 12V battery 80 is connected with the accessories 200. That is, the present power supply system includes three DC power supplies, the high-voltage battery 70, the 12V battery 80, and the 48V battery 90.

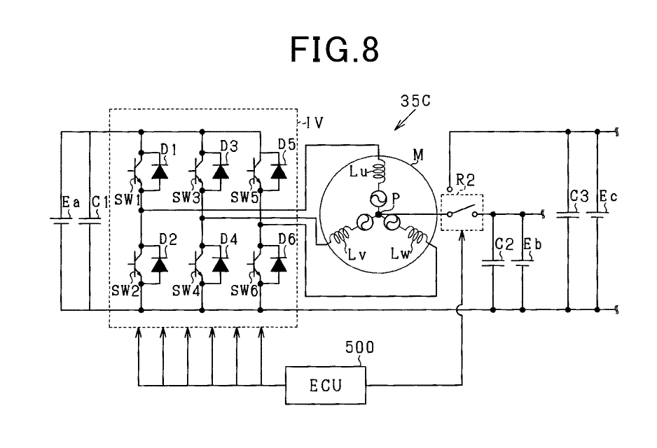

Next, differences of a neutral point step-up and step-down circuit 35C according to the present embodiment from the neutral point step-up and step-down circuit 35A will be described. FIG. 8 shows the neutral point step-up and step-down circuit 35C. In the present embodiment, the traction MG 20 serves as the motor M, and the MG inverter 21 serves as the inverter IV.

The neutral point P of the three phase coils Lu, Lv, and Lw is connected with a first end of the relay R2. The first contact of a second end of the relay R2 is connected with a positive electrode terminal of the power supply Eb. The second contact of the second end of the relay R2 is connected with a positive electrode terminal of the power supply Ec. The power supply Eb and the power supply Ec are respectively connected with the smoothing capacitor C2 and a smoothing capacitor C3 in parallel. When the relay R2 is closed at the first contact, the power supply Eb is connected to the neutral point P. Thereby, electric power is transferred between the power supply Ea (first power supply) and the power supply Eb (second power supply). When the relay R2 is closed at the second contact, the power supply Ec is connected to the neutral point P. Thereby, electric power is transferred between the power supply Ea and the power supply Ec (second power supply).

Note that, as in the case of the neutral point step-up and step-down circuit 35B, the isolation transformer Tr may be provided in the neutral point step-up and step-down circuit 35C. Specifically, the isolation transformer Tr is connected between the first contact of the relay R2 and the positive electrode terminal of the power supply Eb, and the power supply Eb is connected to the high voltage side via the isolation transformer and the relay R2. Furthermore, the isolation transformer Tr is connected between the second contact of the relay R2 and the positive electrode terminal of the power supply Ec, and the power supply Ec is connected to the high voltage side via the isolation transformer and the relay R2.

In the present embodiment, the high-voltage battery 70 serves as the power supply Ea, the 12V battery 80 serves as the power supply Eb, and the 48V battery 90 serves as the power supply Ec. Electric power is transferred between the high-voltage battery 70, the 12V battery 80, and the 48V battery 90 by using the neutral point step-up and step-down circuit 35C. At this time, the clutch CL1 has been disengaged to disconnect the traction MG 20 and the drive shaft 130 from each other. Thus, the neutral point step-up and step-down is performed while the vehicle is stopped. Even while the vehicle is stopped, when the traction MG 20 is generating electric power, the torque output current and the input and output currents of the neutral point P according to the neutral point step-up and step-down flow to the MG inverter 21.

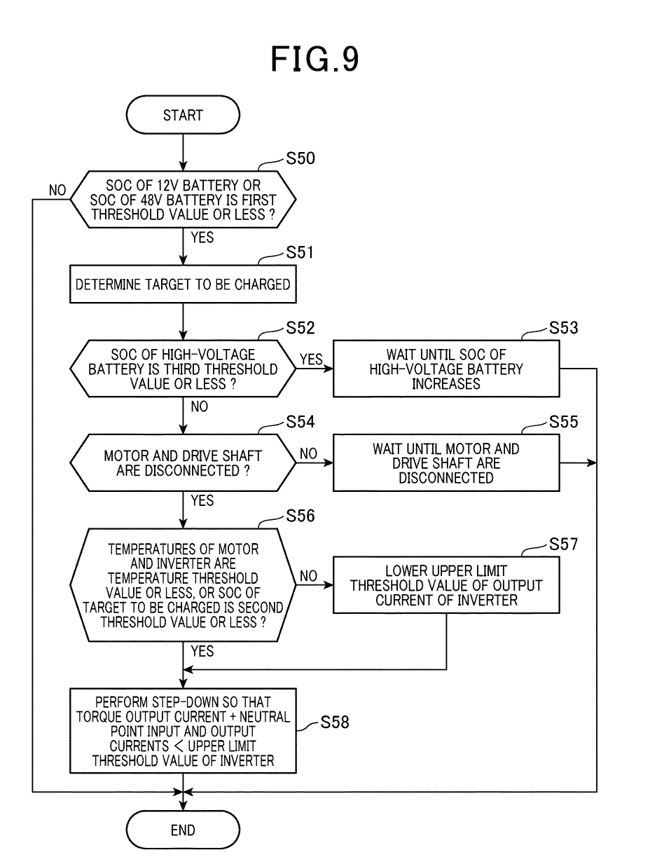

Next, a procedure for performing the neutral point step-down will be described with reference to the flowchart shown in FIG. 9. The present procedure is repeatedly performed by the ECU 500 at predetermined intervals.

First, in step S50, the ECU 500 determines whether or not the SOC of the 12V battery 80 or the SOC of the 48V battery 90 is the corresponding first threshold value Sth1 or less. That is, the ECU 500 determines whether or not the 12V battery 80 or the 48V battery 90 is required to be charged. If both the SOC of the 12V battery 80 and the SOC of the 48V battery 90 are more than the corresponding first threshold values Sth1 (S50: NO), the charging is not required. Hence, the present process is ended. Note that, in this case, the first threshold values Sth1 are individually set for the 12V battery 80 and the 48V battery 90.

If the SOC of the 12V battery 80 or the SOC of the 48V battery 90 is the first threshold value Sth1 or less (S10: YES), in step S51, the ECU 500 determines a target to be charged. If both the SOCs are the first threshold values Sth1 or less, the ECU 500 determines the battery having higher necessity of charging as the target to be charged.

Next, in step S52 to step S55, the ECU 500 performs the processes similar to those of step S11 to step S14. In step S56, the ECU 500 performs the process similar to that of the step S15 in a state where the SOC of the 12V battery 80 used in the determination in step S15 is used as the SOC of the target to be charged. In step S57, the ECU 500 performs the process similar to that of the step S16. In step S58, the ECU 500 closes the relay R2, and connects the battery, which is the target to be charged, to the neutral point P, to perform step-down as in the case of the process of step S17. Then, the battery, which is the target to be charged, is charged with the electric power of the high-voltage battery 70. Then, the present process is ended.

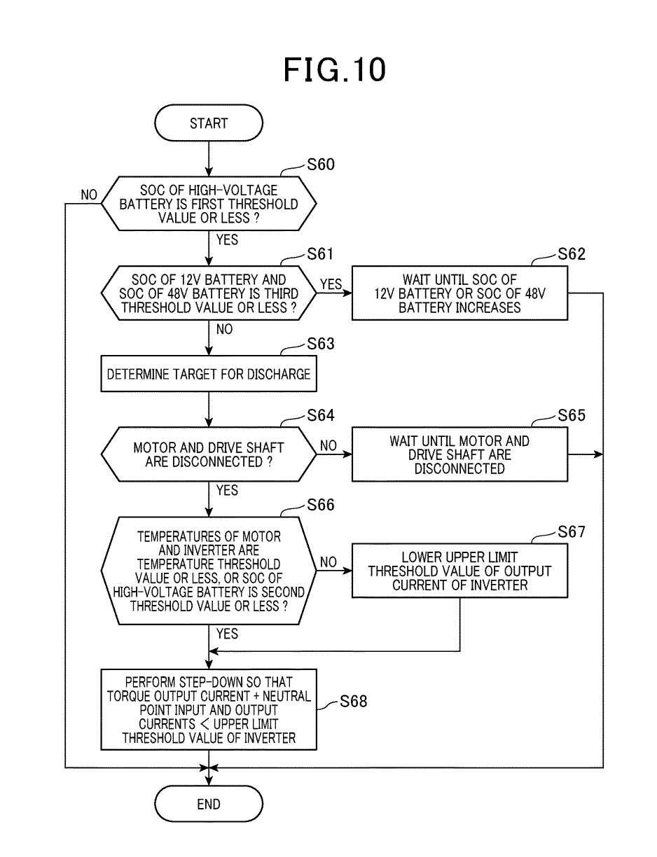

Next, a procedure for performing the neutral point step-up will be described with reference to the flowchart shown in FIG. 10. The present procedure is repeatedly performed by the ECU 500 at predetermined intervals.

First, in step S60, the ECU 500 performs the process similar to that of step S20. Next, in step S61, the ECU 500 determines whether or not the SOC of the 12V battery 80 and the SOC of the 48V battery 90 are the corresponding third threshold values Sth3 or less. In this case, the third threshold values Sth3 are individually set for the 12V battery 80 and the 48V battery 90. If both the SOC of the 12V battery 80 and the SOC of the 48V battery 90 are the third threshold values Sth3 or less (S61: YES), in step S62, the ECU 500 waits until any one of the SOCs exceeds the corresponding third threshold value Sth3. Then, the present process is ended.

In contrast, if any one of the SOC of the 12V battery 80 and the SOC of the 48V battery 90 is more than the corresponding third threshold value Sth3 (S61: NO), in step S63, the ECU 500 determines a target for discharge. In step S60 to step S67, the ECU 500 performs the processes similar to those of step S23 to step S26. In step S68, the ECU 500 closes the relay R2 to connect the battery, which is the target for discharge, to the neutral point P, thereby performing the step-up as in the case of the process of step S27. Then, the high-voltage battery 17 is charged with electric power of the target for discharge. Then, the present process is ended.

According to the third embodiment described above, advantageous effects similar to the advantageous effects (1) to (3) and (5) of the first embodiment are provided. In addition, the following advantageous effects are provided.

(6) Only when the clutch CL2 is disengaged, the neutral point step-up and step-down is performed. Hence, the neutral point step-up and step-down can be performed without affecting the condition of the vehicle.

(7) Even when three or more DC power supplies are provided, electric power can be transferred between the three or more DC power supplies by connecting the appropriately selected DC power supply to the neutral point P.

### Fourth Embodiment

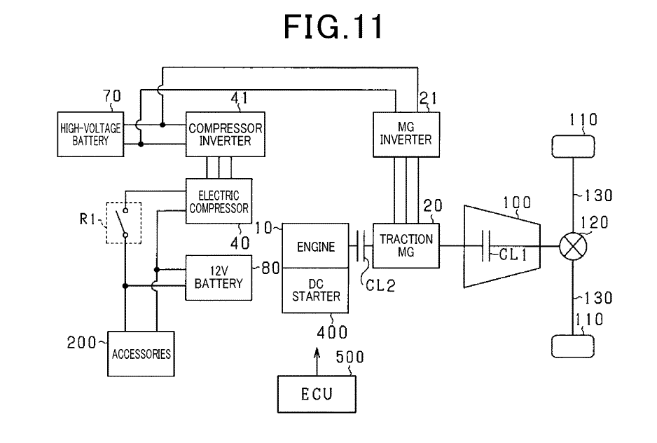

Next, differences of a power supply system according to the fourth embodiment from the power supply system according to the first embodiment will be described. FIG. 11 shows a configuration of a vehicle including the power supply system according to the fourth embodiment. The vehicle includes the engine 10, the traction MG 20, a DC starter 400, an electric compressor 40, the MG inverter 21, a compressor inverter 41, the high-voltage battery 70, the 12V battery 80, the accessories 200, the transmission 100, and the ECU 500.

The DC starter 400 is a DC motor and applies initial rotation to the crankshaft of the engine 10 when the engine 10 starts.

The electric compressor 40 (AC motor) includes scrolls and vanes, and a three-phase AC motor that rotates the scrolls and the vanes. The electric compressor 40 is connected with the compressor inverter 41 that drives the AC motor. The compressor inverter 41 is connected with the high-voltage battery 70 that supplies electric power to the AC motor of the electric compressor 40.

In addition, the neutral point P of the three-phase coils of the AC motor included in the electric compressor 40 is connected with the 12V battery 80 via a relay R1. The 12V battery 80 is connected with the accessories 200.

In addition, the connection between the engine 10, the traction MG 20, the MG inverter 21, the high-voltage battery 70, and the transmission 100 is similar to that of the first embodiment. The high-voltage battery 70 supplies electric power to the electric compressor 40 and the traction MG 20. The present power supply system includes two DC power supplies, the high-voltage battery 70 and the 12V battery 80.

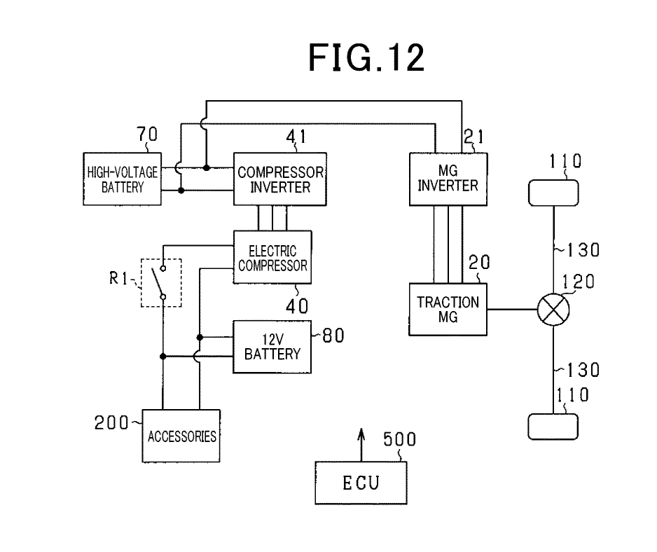

FIG. 12 shows a configuration of a vehicle according to another example of the fourth embodiment. The vehicle according to another example of the present embodiment differs from the vehicle shown in FIG. 11 in that the vehicle according to another example of the present embodiment does not include the engine 10, the DC starter 400, the clutch CL2, and the transmission 100. That is, the vehicle according to another example of the present embodiment is an electric automobile driven only by power of the traction MG 20.

In the present embodiment, the AC motor of the electric compressor 40 and the compressor inverter 41 form the neutral point step-up and step-down circuits 35A and 35B. That is, in the present embodiment, the AC motor of the electric compressor 40 serves as the motor M, and the compressor inverter 41 serves as the inverter IV. In addition, the high-voltage battery 70 serves as the power supply Ea, and the 12V battery 80 serves as the power supply Eb. Thereby, electric power is transferred between the high-voltage battery 70 and the 12V battery 80.

The ECU 500 performs the neutral point step-up and step-down only when the electric compressor 40 is not used for the original purpose. If the neutral point step-up and step-down is performed while the electric compressor 40 is used, unintended torque pulsation due to the neutral point step-up and step-down is transmitted to the scrolls and the vanes, which makes the rotation of the scrolls and the vanes unstable. Furthermore, sounds are produced which differ from those produced when the electric compressor 40 is normally used, which may provide an uncomfortable feeling to a passenger of the vehicle. However, since the neutral point step-up and step-down is performed while the electric compressor 40 is not used, torque pulsation due to the neutral point step-up and step-down is not transmitted into the electric compressor 40, which suppresses the generation of sounds different from those produced when the electric compressor 40 is normally used.

In addition, since the neutral point step-up and step-down is performed while the electric compressor 40 is not used, a torque output current does not flow to the compressor inverter 41 while the neutral point step-up and step-down is performed. Hence, the ECU 500 may control switching of the compressor inverter 41 so that input and output currents due to the neutral point step-up and step-down becomes less than the upper limit threshold value Ith.

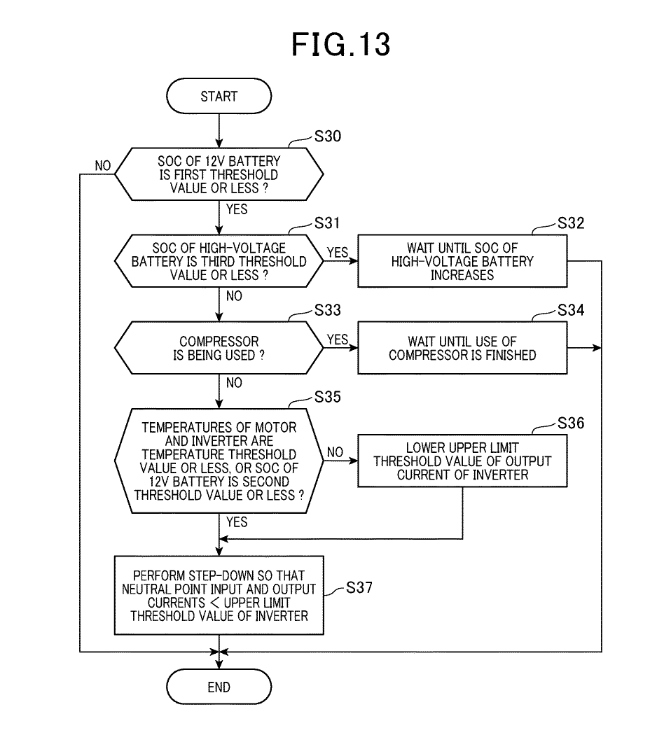

Next, a procedure for performing the neutral point step-down will be described with reference to the flowchart shown in FIG. 13. The present procedure is repeatedly performed by the ECU 500 at predetermined intervals.

First, in step S30 to step S32, the ECU 500 performs the processes similar to those of step S10 to step S12. If the SOC of the high-voltage battery 70 is the third threshold value Sth3 or more (S31: NO), in step S33, the ECU 500 determines whether or not the electric compressor 40 is being used. If the electric compressor 40 is being used (S33: YES), in step S34, the ECU 500 waits until the use of the electric compressor 40 is finished. Then, the present process is ended.

In contrast, if the electric compressor 40 is not being used (S33: NO), in step S35 and step S36, the ECU 500 performs the processes similar to those of step S15 to step S16.

Next, in step S37, the ECU 500 closes the relay R1, and connects the 12V battery 80 to the neutral point P. Then, the ECU 500 performs the step-down of the voltage of the high-voltage battery 70 so that the neutral point input and output currents according to the step-down become less than the upper limit threshold value Ith of the output current of the compressor inverter 41. Then, the 12V battery 80 is charged with the electric power of the high-voltage battery 70. Then, the present process is ended.

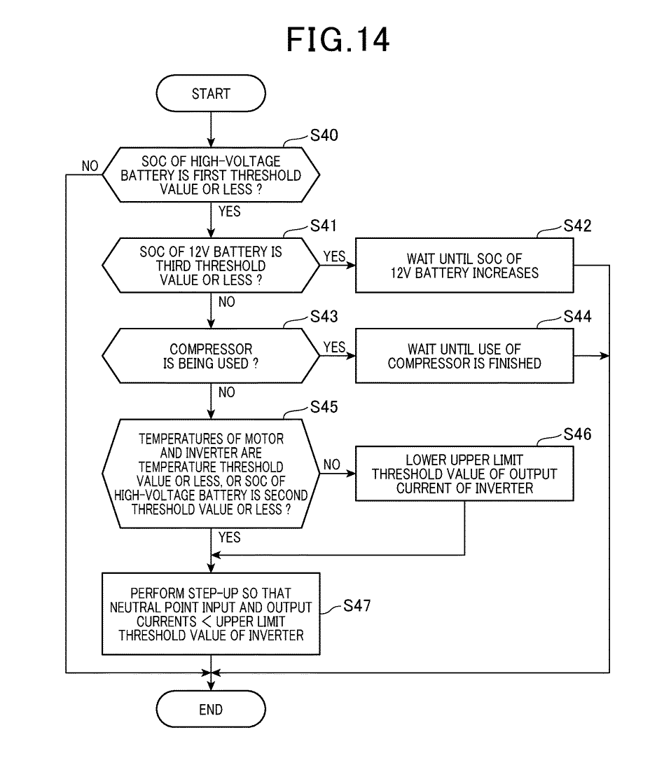

Next, a procedure for performing the neutral point step-up will be described with reference to the flowchart shown in FIG. 14. The present procedure is repeatedly performed by the ECU 500 at predetermined intervals.

First, in step S40 to step S42, the ECU 500 performs the processes similar to those of step S20 to step S22. If the SOC of the 12V battery 80 is the third threshold value Sth3 or more (S41: NO), in step S43, the ECU 500 determines whether or not the electric compressor 40 is being used. If the electric compressor 40 is being used (S43: YES), in step S44, the ECU 500 waits until the use of the electric compressor 40 is finished. Then, the present process is ended.

In contrast, if the electric compressor 40 is not being used (S43: NO), in step S45 and step S46, the ECU 500 performs the processes similar to those of step S25 to step S26.

Next, in step S47, the ECU 500 closes the relay R1, and connects the 12V battery 80 to the neutral point P. Then, the ECU 500 performs the step-up of the voltage of the 12V battery 80 so that the neutral point input and output currents according to the step-up become less than the upper limit threshold value Ith. Then, the high-voltage battery 70 is charged with electric power from the 12V battery 80. Then, the present process is ended.

According to the fourth embodiment described above, the advantageous effects similar to the advantageous effects (2), (3), and (5) of the first embodiment are provided. In addition, the following advantageous effects are provided.

(8) Only when the electric compressor 40 is not use, the neutral point step-up and step-down is performed by using the step-up and step-down circuit formed of the AC motor of the electric compressor 40 and the compressor inverter 41. Hence, even when torque is generated when the neutral point step-up and step-down is performed, the transmission of torque pulsation into the electric compressor 40 can be suppressed. Hence, the generation of sounds that differ from those produced when the electric compressor 40 is normally used can be suppressed.

### Fifth Embodiment

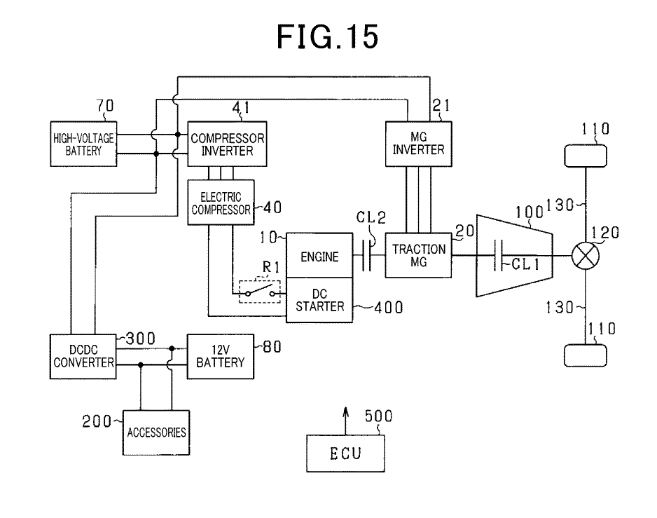

Next, differences of a power supply system according to the fifth embodiment from the power supply system according to the fourth embodiment will be described. FIG. 15 shows a configuration of a vehicle including the power supply system according to the fifth embodiment. The vehicle includes the engine 10, the traction MG 20, the DC starter 400, the electric compressor 40, the MG inverter 21, the compressor inverter 41, the high-voltage battery 70, the 12V battery 80, the accessories 200, a DCDC converter 300, the transmission 100, and the ECU 500.

The connection between the engine 10, the DC starter 400, the traction MG 20, the MG inverter 21, the high-voltage battery 70, and the transmission 100 is similar to that of the fourth embodiment. Furthermore, in the present embodiment, the DC starter 400 is connected the neutral point P of the three-phase coils of the AC motor included in the electric compressor 40, via the relay R1.

The DCDC converter 300 is connected between the high-voltage battery 70 and the 12V battery 80. The DCDC converter 300 decreases the voltage of the high-voltage battery 70 and outputs the voltage to the 12V battery 80. In addition, the DCDC converter 300 increases the voltage of the 12V battery 80 and outputs the voltage to the high-voltage battery 70. That is, in the present embodiment, electric power is transferred between the high-voltage battery 70 and the 12V battery 80 via the DCDC converter 300.

In the present embodiment, the AC motor of the electric compressor 40 and the compressor inverter 41 form the neutral point step-up and step-down circuits 35A and 35B. Note that, in the present embodiment, step-up is not performed, but step-down is performed, by using the neutral point step-up and step-down circuits 35A and 35 B. The high-voltage battery 70 serves as the power supply Ea, and the DC starter 400 is connected instead of the power supply Eb. That is, when the engine 10 starts, the relay R1 is closed, and the DC starter 400 is connected to the neutral point P. Then, the voltage of the high-voltage battery 70 is decreased, and electric power of the high-voltage battery 70 is supplied to the DC starter 400. At this time, the ECU 500 performs step-down according to a request output from the DC starter 400 to control the voltage applied to the DC starter 400.

The step-down of the voltage of the high-voltage battery 70 is performed under the procedure similar to that of the flowchart shown in FIG. 13. Note that, in step S30, the ECU 500 determines whether or not the engine 10 starts. In addition, in step S35, instead of determining whether or not the SOC of the 12V battery 80 is the second threshold value Sth2 or less, the ECU 500 determines whether or not a request output from the DC starter 400 is a threshold value or more.

According to the fourth embodiment described above, the advantageous effects similar to those of the fifth embodiment are provided. In addition, the following advantageous effects are provided.

(9) Controlling the voltage supplied to the DC starter 400 can control the output of the DC starter 400.

### Other Embodiments

In the first to third embodiments, currents flowing to the coils of the motor M may be suppressed when the motor M and the drive shaft 130 are connected to each other, compared with when the motor M and the drive shaft 130 are disconnected from each other, to perform the neutral point step-up and step-down. Even in this case, since the generation of torque is suppressed when the neutral point step-up and step-down is performed, torque pulsation transmitted to the drive shaft 130 is suppressed. Hence, the neutral point step-up and step-down can be performed while affecting the condition of the vehicle is suppressed.

In the fourth and fifth embodiments, when the electric compressor 40 is used for the original purpose, the amount of currents flowing to the coils of the AC motor of the electric compressor 40 is suppressed compared with when the electric compressor 40 is not used for the original purpose, to perform the neutral point step-up and step-down. Even in this case, since the generation of torque is suppressed when the neutral point step-up and step-down is performed, torque pulsation transmitted into the electric compressor 40 is suppressed. Hence, the generation of sounds that differ from those produced when the electric compressor 40 is normally used can be suppressed.

In the fifth embodiment, the DC starter 400 may be replaced with a DC motor that drives a hydraulic pump. That is, instead of the DC starter 400, the DC motor driving the hydraulic pump may be connected to the neutral point step-up and step-down circuits 35A and 35B to supply electric power of the high-voltage battery 70 to the DC motor that drives the hydraulic pump.

In the embodiments, the plurality of different DC power supplies may be different types of batteries with the same voltage and are formed of different materials. In addition, the plurality of different DC power supplies may be the same type of batteries with different voltages.

The power supply system, in the fourth embodiment, forming the neutral point step-up and step-down circuits 35A and 35B by using the AC motor of the electric compressor 40 may be applied to a vehicle that does not include the traction MG 20 or the ISG and uses only the engine 10 as a traveling drive source.

It will be appreciated that the present invention is not limited to the configurations described above, but any and all modifications, variations or equivalents, which may occur to those who are skilled in the art, should be considered to fall within the scope of the present invention.

Hereinafter, aspects of the above-described embodiments will be summarized.

As an aspect of the embodiment, a power supply system is applied to a vehicle. The system includes: a plurality of different DC power supplies (70, 80, 90); an AC rotating electrical machine (30, 60, 20); an inverter (31, 61, 21) that is connected between a first power supply (70, 90) included in the DC power supplies and the AC rotating electrical machine to drive the AC rotating electrical machine, and a controller (500) that controls switching of switching elements of the inverter. A first end of one of at least one second power supply (80, 90) included in the DC power is connected to a terminal of a same polarity side of the first power supply, and a second end of the second power supply is connected to a neutral point (P) of windings of the AC rotating electrical machine. The AC rotating electrical machine and a drive shaft (130) of the vehicle are connected to each other or disconnected from each other. When the

AC rotating electrical machine and the drive shaft are disconnected from each other, the controller controls the switching to perform step-down or step-up of the first power supply or the second power supply by using the windings, or when the AC rotating electrical machine and the drive shaft are connected to each other, the controller suppresses a current flowing to the windings compared with when the AC rotating electrical machine and the drive shaft are disconnected from each other to perform the step-down or the step-up, so that electric power is transferred between the first power supply and the second power supply.

According to the power supply system, field windings of the AC rotating electrical machine and the switching elements of the inverter form a step-up and step-down circuit using the neutral point of the field windings. Only when the AC rotating electrical machine and the drive shaft of the vehicle is disconnected from each other, neutral point step-up and step-down of the first power supply or the second power supply is performed. Hence, even if torque pulsation is generated when the neutral point step-up and step-down is performed, the torque pulsation is not transmitted to the drive shaft. In contrast, when the AC rotating electrical machine and the drive shaft of the vehicle are connected to each other, the neutral point step-up and step-down is performed in the state where currents flowing to the field windings are suppressed according to the neutral point step-up and step-down compared with when the AC rotating electrical machine and the drive shaft are disconnected from each other. Hence, since torque generated when the neutral point step-up and step-down is performed is suppressed, torque pulsation transmitted to the drive shaft is suppressed. Hence, the neutral point step-up and step-down can be performed while the application of unintended torque pulsation to a connecting object of the AC rotating electrical machine is suppressed. Furthermore, the neutral point step-up and step-down can be performed while suppressing the effect of the torque pulsation on the condition of the vehicle.

As another aspect of the embodiment, a power supply system includes: a plurality of different DC power supplies (70, 80); an AC motor included in an electric compressor (40); an inverter (41) that is connected between a first power supply (70) included in the DC power supplies and the AC motor to drive the AC motor; a DC motor (400); and a controller (500) that controls switching of switching elements of the inverter. A first end of a second power supply (80) included in the DC power supplies or the DC motor is connected to a terminal of a same polarity side of the AC motor, and a second end of the second power supply or the DC motor is connected to a neutral point of windings of the AC motor. When the electric compressor is not used, the controller controls the switching to perform step-down of the first power supply or the step-up of the second power supply by using the windings, or when the electric compressor is used, the controller suppresses a current flowing to the windings compared with when the electric compressor is not used, to perform the step-down or the step-up.

According to the power supply system, field windings of the AC motor included in the electric compressor and the switching elements of the inverter form a step-up and step-down circuit using the neutral point of the field windings. Only when the electric compressor is not used, step-down of the first power supply or step-up of the second power supply is performed. Hence, even if torque is generated when the neutral point step-up and step-down is performed, the torque pulsation is not transmitted into the electric compressor. In contrast, when the electric compressor is used, the neutral point step-up and step-down is performed in the state where currents flowing to the field windings are suppressed according to the neutral point step-up and step-down compared with when the electric compressor is not used. Hence, since torque generated when the neutral point step-up and step-down is performed is suppressed, torque pulsation transmitted into the electric compressor is suppressed. Hence, the neutral point step-up and step-down can be performed while the application of unintended torque pulsation to a connecting object of the AC motor is suppressed. Furthermore, the rotation of the electric compressor is prevented from being unstable, thereby suppressing the generation of sounds different from those produced when the electric compressor is normally used.

What is claimed is:

1. A power supply system that is applied to a vehicle, the system comprising:
a plurality of different DC power supplies;
an AC rotating electrical machine;
an inverter that is connected between a first power supply included in the DC power supplies and the AC rotating electrical machine to drive the AC rotating electrical machine, and
a controller that controls switching of switching elements of the inverter, wherein
a first end of one of at least one second power supply included in the DC power is connected to a terminal of a same polarity side of the first power supply, and a second end of the second power supply is connected to a neutral point of windings of the AC rotating electrical machine,
the AC rotating electrical machine and a drive shaft of the vehicle are connected to each other or disconnected from each other,
when the AC rotating electrical machine and the drive shaft are disconnected from each other, the controller controls the switching to perform step-down or step-up of the first power supply or the second power supply by using the windings, or when the AC rotating electrical machine and the drive shaft are connected to each other, the controller suppresses a current flowing to the windings compared with when the AC rotating electrical machine and the drive shaft are disconnected from each other to perform the step-down or the step-up, so that electric power is transferred between the first power supply and the second power supply.

2. The power supply system according to claim 1, wherein
when the controller performs the step-down or the step-up, the controller makes a sum of an output current corresponding to torque of the AC rotating electrical machine and input and output currents input to and output from the neutral point according to the step-up and the step-down smaller than a maximum current allowed to flow to the inverter.

3. The power supply system according to claim 1, wherein
when the controller performs the step-down or the step-up, if at least one of temperatures of the AC rotating electrical machine and the inverter is higher than a temperature threshold value, and if a charging rate of the DC power supply, which is a target to be charged, is higher than a charging threshold value, the controller lowers the maximum current allowed to flow to the inverter.

4. The power supply system according to claim 1, wherein
the AC rotating electrical machine is connected to the drive shaft via the engine, and
when the AC rotating electrical machine and the engine are disconnected from each other, the controller performs the step-down or the step-up.

5. The power supply system according to claim 1, wherein
the AC rotating electrical machine is connected to the engine that is connected to the drive shaft via a clutch, and
when the clutch is disengaged, the controller performs the step-down or the step-up.

6. The power supply system according to claim 1, wherein
the AC rotating electrical machine is a traveling drive source of the vehicle,
the AC rotating electrical machine is connected to the drive shaft via a clutch, and
when the clutch is disengaged, the controller performs the step-down or the step-up.

7. The power supply system according to claim 6, wherein
the plurality of different DC power supplies include the plurality of different second power supplies,
the AC rotating electrical machine is driven by electric power of the first power supply, and
the controller connects the second end of any one of the second power supplies to the neutral point so that the electric power is transferred between the first power supply and the any one of the second power supplies.

8. The power supply system according to claim 1, wherein
the second end of the second power supply is connected to the neutral point via an isolation transformer, and the first end of the second power supply is connected to the terminal of the same polarity side of the first power supply via the isolation transformer.

9. A power supply system, comprising:
a plurality of different DC power supplies;
an AC motor included in an electric compressor;
an inverter that is connected between a first power supply included in the DC power supplies and the AC motor to drive the AC motor;
a DC motor; and
a controller that controls switching of switching elements of the inverter, wherein
a first end of a second power supply included in the DC power supplies or the DC motor is connected to a terminal of a same polarity side of the AC motor, and a second end of the second power supply or the DC motor is connected to a neutral point of windings of the AC motor,
when the electric compressor is not used, the controller controls the switching to perform step-down of the first power supply or the step-up of the second power supply by using the windings, or when the electric compressor is used, the controller suppresses a current flowing to the windings compared with when the electric compressor is not used, to perform the step-down or the step-up.

10. The power supply system according to claim 9, wherein
the terminal of the same polarity side of the AC motor is connected with the first end of the DC motor, and the neutral point is connected with the second end of the DC motor, and
the controller performs step-down of the DC power supply according to a request output from the DC motor.
